(19) United States
(12) Patent Application Publication
(10) Pub. No.: US 2010/0207075 A1
(43) Pub. Date: Aug. 19, 2010

(54) METHOD FOR PRODUCING METAL COMPLEX OXIDE POWDER

(75) Inventor: Koh Takahashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Universal Entertainment Corporation, Tokyo (JP)

(21) Appl. No.: 12/678,899

(22) PCT Filed: Aug. 27, 2008
(86) PCT No.: PCT/JP08/65255

§ 371 Date: Mar. 18, 2010

(30) Foreign Application Priority Data
Sep. 26, 2007 (JP) 2007-249202

(51) Int. Cl. C01G 45/02; C01B 13/00; C01D 1/02; C01F 11/02; H01B 1/02; C01F 17/00

(52) U.S. Cl. 252/519.1; 423/593.1; 423/594.15; 423/594.16; 423/599; 423/263

(57) ABSTRACT

Disclosed is a low-cost metal complex oxide material which has excellent stability at high temperatures and good crystallinity, while placing only a little burden on the environment. Specifically disclosed is a method for producing a metal complex oxide powder represented by the following general formula: ABO₃ (wherein A represents an oxygen 12 coordinated metal element and B represents an oxygen 6 coordinated metal element). This method for producing a metal complex oxide powder is characterized in that a chloride containing the element A, a chloride containing the element B and an aqueous solution containing an alkali carbonate are reacted as represented by the reaction formula below for producing a precipitate, and then the thus-produced precipitate is fired.

(1−x)CaCl₂₊ₓ.MCl₃+(2+0.5x)Na₂Co3→(1−x)CaCO₃↓+0.5x.M₂CO₃↓+MnCO₃↓+(4+x)NaCl

### TECHNICAL FIELD

The present invention relates to a method for producing a metal complex oxide powder useful as a thermoelectric conversion material, and particularly relates to a perovskite-type complex oxide powder containing a rare earth element, an alkali earth metal element, and manganese.

### BACKGROUND ART

Solid-phase synthesis methods and liquid-phase synthesis methods have been known from the prior art as methods for producing metal complex oxides. The solid-phase synthesis method, which is a more common method, is a method that obtains the target oxide powder by carrying out a solid reaction at high temperature, after mixing powders of oxides, carbonates or the like of each constituent element. Although this method has an advantage in that the operation is relatively simple and the raw materials are low priced, the mixing of the raw material oxide powders easily becomes non-uniform. As a result, there are disadvantages in that the constitution of the metal complex oxide thus obtained easily becomes non-uniform, and thus a material having high functionality is not obtained.

On the other hand, the liquid-phase synthesis method has an advantage in that raw materials are uniformly mixed and reacted. A hydrothermal method, coprecipitation method, and the like have been known as liquid-phase synthesis methods. Furthermore, a synthesis method of the metal complex oxides using the hydrothermal method (refer to Japanese Unexamined Patent Application Publication No. H05-238735), and a synthesis method of metal complex oxides using the coprecipitation method (refer to Japanese Unexamined Patent Application Publication No. 2005-225735) have both been disclosed.

In Japanese Unexamined Patent Application Publication No. H05-238735, a method is disclosed that is a method for producing oxides represented by the general formula ABO₃, in which a precipitate of hydroxides of element A and element B are generated by reacting a compound containing element A and a compound containing element B with a lithium hydroxide aqueous solution, and filtering and washing, and then drying this precipitate. However, with the method of Japanese Unexamined Patent Application Publication No. H05-238735, it is necessary to dissolve all or a portion of the precipitate at high temperature and under high pressure in order to obtain a perovskite-type oxide by causing reaction with the precipitate, and thus requires labor as well as the expense it takes.

In addition, in Japanese Patent Application Publication No. 2005-225735, a method for producing a high orientation thermoelectric conversion material is disclosed in which a sheet-shaped compact, to which a suspension liquid containing a sheet-shaped single crystal powder and a sintered body powder produced by the coprecipitation method is oriented, is formed, and then laminated and sintered, to be NaxCoO₂ (0.3≦x≦0.8) with at least 70% degree of (001) surface orientation. According to this method, a metal complex oxide that excels in high-temperature stability and has little environmental burden is obtained; however, since high-priced cobalt is contained as a main ingredient, great cost becomes necessary upon undertaking universalization and enlargement.

### DISCLOSURE OF THE INVENTION

### Problems to be Solved by the Invention

The present invention was made in order to solve the above problems, and an object thereof is to provide a production method that can easily obtain metal complex oxide material at low cost, excelling in high temperature stability, having little environmental burden, and having favorable crystallinity.

### Means for Solving the Problems

The present inventors have focused on and thoroughly investigated improving crystallinity in order to improve the thermoelectric characteristics of a thermoelectric conversion element. As a result, they discovered that a thermoelectric conversion material excelling in thermoelectric characteristics could be easily synthesized by employing a coprecipitation method in mixing raw materials, and thus arrived at completing the present invention. More specifically, the present invention provides the following.

According to a first aspect, in a method for producing a metal complex oxide powder represented by the general formula ABO₃, in which A is an oxygen 12-coordinated metallic element and B is an oxygen 6-coordinated metallic element,

a precipitate is generated by reacting a chloride containing element A and a chloride containing element B, and an aqueous solution containing an alkaline carbonate; and the precipitate thus generated is calcined.

According to the first aspect of the invention, only an alkali chloride is generated as a residual product other than a complex carbonate by causing the chlorides and the alkaline carbonate aqueous solution to react. Examples of the alkali chloride include sodium chloride (table salt) or potassium chloride, and ammonium chloride (manure) and the like, and since it can be reused industrially and chemically as well, it can have little environmental burden and excels in environmental friendliness also.

According to a second aspect, in the method for producing a metal complex oxide powder as described in the first aspect, the metal complex oxide powder is a perovskite-type complex oxide powder.

According to the second aspect of the invention, a perovskite-type complex oxide, which is a perovskite-type complex oxide that is widely used in thermoelectric conversion materials, electrode materials and the like having high crystallinity, can be produced at low cost.

According to a third aspect, in the method for producing a metal complex oxide powder as described in the first or second aspect, at least one type selected from the group consisting of lithium carbonate, sodium carbonate, potassium carbonate, and ammonium carbonate is used as the alkaline carbonate.

According to the third aspect of the invention, employing sodium carbonate or potassium carbonate, and ammonium carbonate and the like as the alkaline carbonate is preferred. Due to this, sodium chloride (table salt) or potassium chloride, and ammonium chloride (manure), which are generated as the alkali chloride, can be reused industrially and chemically, and thus have little environmental burden and excel in environmental friendliness also.

According to a fourth aspect, in the method for producing a metal complex oxide powder as described in any one of the first to third aspects, in the general formula ABO₃, a main component of an A site is Ca₍₁₋ₓ₎Mₓ, in which M is at least one element selected from the group consisting of yttrium and a lanthanoid, and x is in the range of 0.001 to 0.05; and a main component of a B site is Mn.

According to the fourth aspect of the invention, by making the general formula ABO₃ of the perovskite-type complex oxide be the general formula Ca₍₁₋ₓ₎MₓMnO₃, in which M is at least one element selected from the group consisting of yttrium and a lanthanoid, and x is in the range of 0.001 to 0.05, a thermoelectric conversion material having high heat resistance and excelling in thermoelectric characteristics can be produced at low cost.

### EFFECTS OF THE INVENTION

According to the present invention, in a case of producing a metal complex oxide powder represented by the general formula ABO₃, in which A is an oxygen 12-coordinated metallic element, B is an oxygen 6-coordinated metallic element, and O is oxygen, a metal complex oxide powder excelling in high temperature stability, having little environmental burden, and having favorable crystallinity can be obtained at low cost by generating a precipitate by causing a chloride containing element A and a chloride containing element B to react with an aqueous solution containing an alkaline carbonate, and using the precipitate thus generated as a raw material.

### PREFERRED MODE FOR CARRYING OUT THE INVENTION

Although embodiments of a metal complex oxide powder of the present invention are described in detail below, the present invention is in no way limited to the following embodiments, and suitable modifications thereto can additional be carried out within the scope of the object of the present invention. It should be noted that, for passages in which descriptions overlap, the description may be suitably omitted; however, this is not to limit the spirit of the present invention.

### Method for Producing Metal Complex Oxide Powder

The method for producing a metal complex oxide powder of the present invention is a method for producing a metal complex oxide powder represented by the general formula ABO₃, in which A is an oxygen 12-coordinated metallic element and B is an oxygen 6-coordinated metallic element, and is not particularly limited so long as being a production method that generates a precipitate by causing a chloride containing element A and a chloride containing element B to react with an aqueous solution containing an alkaline carbonate, and calcines the precipitate thus generated.

First, the raw materials are weighed and mixed. Although aspects of the raw materials are not particularly limited, since it is necessary for the raw materials to be dissolved in solvent, they are preferably powdered raw materials.

The raw materials of the present invention that are weighed are the chloride containing element A and the chloride containing element B. In addition, yttrium chloride and/or lanthanum chloride can be added to the raw materials in order to further improve the heat resistance of the metal complex oxide powder at high temperatures.

The chloride containing element A is not particularly limited so long as being an oxygen 12-coordinated metallic element; however, it is exemplified by calcium chloride. The chloride containing element B is not particularly limited so long as being an oxygen 6-coordinated metallic element; however, it is exemplified by manganese chloride.

Next, as represented in the reaction formula described below, a precipitate is obtained by adding an aqueous solution of the raw material mixture to the alkaline carbonate. By allowing the chlorides and the alkaline carbonate aqueous solution to react, other than a complex carbonate, only an alkali chloride of the liquid is generated. Therefore, the mixed condition becomes favorable and the raw material becomes uniformly mixed since an alkali metal is not mixed therein. A metal complex oxide powder having high crystallinity can be generated by generating a metal complex oxide powder using this precipitate. In addition, although the alkali chloride thus generated is sodium chloride or calcium chloride, and ammonium chloride; all of these chlorides have little environmental burden.

(1−x)CaCl₂₊ₓ.MCl₃+(2+0.5x)Na₂Co₃→(1−x) CaCO₃↓+0.5x.M₂CO₃↓+MnCO₃↓+(4+x)NaCl

M is yttrium or lanthanum. The down arrows represent being a precipitate.

The alkali carbonate is exemplified by lithium carbonate, sodium carbonate, potassium carbonate, and ammonium carbonate. A carbonate containing A, a carbonate containing B and an alkali chloride are generated from the reaction of the chloride containing element A and the chloride containing element B. The carbonate containing this element A and the carbonate containing this element B are generated in a uniformly mixed state as a precipitate, and the alkali chloride is generated as a liquid in the solution remaining.

A method in which a chloride containing element A, a chloride containing element B and an alkaline carbonate are reacted is not particularly limited so long as an objective carbonate is generated; however, a method in which the raw materials are made an aqueous solution in a predetermined mixing ratio, this raw material mixed aqueous solution is dropped into an alkaline carbonate solution, and a complex carbonate is precipitated is preferred because segregation occurring due to the difference according to raw material type in precipitation rates of precipitates.

Next are steps of filtering, washing and drying the precipitate thus obtained. In this way it is possible to remove the alkali chloride and the like remaining in the precipitate.

The method of filtering and washing is not particularly limited; however, a method in which filtering and washing is performed using purified water can be exemplified. In addition, the drying method is not particularly limited.

Next, the precipitate thus dried is preliminarily calcined. By including a preliminary calcination step, since reactivity is lowered by the preliminary calcine being more stable than the raw material oxide powder that constitutes the complex oxide, abnormal grain growth and generation of a glass phase during the main calcination are suppressed, and thus the high-temperature strength characteristics of the material are further improved.

Carrying out preliminary calcination indicates causing a mixed substance to change into a different substance by reacting at high temperature. In addition, it is also a process that raises the density of a compact.

In preliminary calcination, a heating apparatus such as an electric furnace or gas furnace is employed. The type of heating apparatus is not particularly limited, and can be used so long as being that which achieves calcination of the mixed raw materials in a desired atmosphere at a desired temperature in a desired time period. If giving an example of a case in which an electric furnace is employed as the heating apparatus, a tubular atmosphere furnace, an atmosphere controlled box-type furnace, a belt-conveyor furnace, a roller-hearth furnace, a continuous tray pusher furnace or the like can be employed. In addition, generally, mixed raw materials are placed into a calcination container such as a crucible or boat, the calcination container is covered according to the situation, and is heated along with the calcination container; however, only the mixed raw material may be calcined without using the calcination container. It should be noted that a container composed of platinum, quartz, alumina, zirconia, magnesia, silicon carbide, silicon nitride, porcelain, carbon or the like can be used as the calcination container, and according to the situation, these can be compounded to use.

Although the calcination conditions of preliminary calcination are not particularly limited, the calcination temperature is preferably 900 to 1100° C., and more preferably 950 to 1050° C. This range of calcination temperature is preferred because when calcined at 900° C. or higher, the reaction is substantially completed, and is preferred when calcined at 1100° C. or less because over-sintering and abnormal grain growth can be suppressed.

The calcination time is preferably two to ten hours. More preferably, it is three to seven hours. When two or more hours, it is preferred because the reaction can substantially complete, and when ten or less hours, it is preferred because over-sintering and abnormal grain growth can be suppressed.

The preliminary calcination atmosphere is desirably carried out in an oxidizing atmosphere such as an air and oxygen flow.

The number of times calcining is not particularly limited so long as a desired crystal can be obtained; however, and a small number of times is preferred from the view point of raising production efficiency.

### Method for Producing Metal Complex Oxide

The metal complex oxide of the present invention is not particularly limited so long as being obtained by molding the above-mentioned metal complex oxide powder. By molding the metal complex oxide powder, it becomes possible to use as a thermoelectric conversion material. Since a thermoelectric conversion material using the metal complex oxide of the present invention has high crystallinity in the metal complex oxide, the resistivity of the thermoelectric conversion material is lowered, and thus the output factor of the thermoelectric conversion material becomes high.

Although the molding can employ methods such as press molding, plastic shaping, cast molding, and doctor-blade molding, it is preferably press molding. It should be noted that the pressure when carrying out press molding is preferably 0.5 to 2 t/cm², and is more preferably 0.8 to 1.2 t/cm² (1 kgf/cm²=9.80665×10⁴(Pa)). In addition, the molding process may be either a dry-molding process or wet-molding process.

### Metal Complex Oxide

The metal complex oxide powder produced by the present invention is not particularly limited so long as being an oxide containing at least two kinds of metal ions. As an example of an oxide containing at least two kinds of metal ions, a perovskite-type complex oxide represented by the general formula ABO₃, in which A is an oxygen 12-coordinated metallic element and B is an oxygen 6-coordinated metallic element, can be exemplified.

Although a perovskite-type compound is represented by the general formula of ABO₃, according to the production conditions, oxygen may be in excess, or an oxygen shortage may occur; however, such an oxygen surplus or oxygen shortage may be included therein. Furthermore, the perovskite-type compound takes on various crystal structures such as cubic, tetragonal crystal, orthorhombic, and monoclinic; however, it may belong to any crystalline system and is not particularly limited. However, due to having a crystal structure with higher crystallinity, and thus high carrier mobility is easily obtainable, it is desired to be a cubic system, tetragonal system or orthorhombic system.

As an example of the perovskite-type metal complex oxide, an oxide can be exemplified in which the metallic element of the A site has been replaced with Ca₍₁₋ₓ₎Mₓ, to be represented by the general formula Ca₍₁₋ₓ₎MₓMnO₃, in which M is at least one type of element selected from the group consisting of yttrium and a lanthanoid, and x is in the range of 0.001 to 0.05. Since a carrier can be introduced by adding these elements, it is possible to greatly improve electrical conductivity. x represents a substitution rate when substituting Ca with a trace element. Although the optimum substitution amount differs according to the application, when using as a thermoelectric conversion material, for example, x is preferably 0.001 to 0.05, and more preferably 0.01 to 0.03. The substitution rate being at least 0.001 is preferred because the electrical conductivity becomes at least 10 (S/cm), and being no more than 0.05 is preferred because the absolute value of the Seebeck coefficient becomes at least 150 μV/K.

### Application

For example, Ca₍₁₋ₓ₎MₓMnO₃, which is the metal complex oxide powder produced by the present invention, in which M is at least one element selected from yttrium and a lanthanoid, and x is in the range of 0.001 to 0.05, can be employed as a thermoelectric conversion material.

Thermoelectric conversion refers to applying the Seebeck effect and Peltier effect, and mutually converting thermal energy to electrical energy. When using thermoelectric conversion, it is possible to extract electric power from heat flow using the Seebeck effect, and to bring about an endothermic cooling phenomenon by flowing electric current using the Peltier effect. In a thermoelectric conversion element, a single element composed of metal and semiconductor is generally employed, and the performance index thereof depends on the high-order structure (degree of crystallinity, etc.) of the compound of the thermoelectric conversion material. As a result, it is necessary to make a compound having few structural defects the thermoelectric conversion material in order to obtain a single element with a high performance index. Since the metal complex oxide powder produced by the present invention may include a compound having electrical conductivity, it can also be used as a conductive material. Therefore, it can be used in a thermoelectric conversion material.

There is a compound produced by the present invention, and possessing electrical conductivity in the metal complex oxide powder, and thus it can also be used as a conductive material. For example, it can be used in electrodes.

### EXAMPLES

### Example 1

0.098 mol of calcium chloride, 0.1 mol of manganese chloride and 0.002 mol of yttrium chloride were dissolved in 200 ml of purified water to make a raw material aqueous solution. Meanwhile, an aqueous solution dissolving 0.201 mol of sodium carbonate in 500 ml of purified water was prepared in a one-liter beaker, and agitated at 250 rpm. A raw material aqueous solution was dropped into this sodium carbonate aqueous solution to perform coprecipitation. After the dropping had completed, agitation was continued for approximately 15 minutes. Thereafter, a carbonate mixed powder was obtained by filtering and drying.

The carbonate mixed powder thus obtained was observed by SEM, whereby it was found to be small particles having particle diameters entirely of 1 μm or less. As a comparison, that made by carrying out mixed pulverizing with a common solid-phase made was confirmed to have approximately 1 to 3-μm particles.

Furthermore, this powder was preliminarily calcined in air at 1000° C. for five hours, and then SEM observation was carried out for the preliminary calcined powder thus pulverized. The preliminary calcined powder obtained by the present invention were particles having a particle diameter of no more than 0.5 μm, and resulted in having little scatter in the particle diameter. The particle diameter of the preliminary calcined powder by the solid-phase method were approximately 0.5 to 1-μm particles, and there were also 1 μm and larger particles existing among these.

1. A method for producing a metal complex oxide powder represented by formula ABO₃, in which A is an oxygen 12-coordinated metallic element and B is an oxygen 6-coordinated metallic element,
wherein a precipitate is generated by reacting a chloride comprising an element A, a chloride comprising an element B, and aqueous solution comprising an alkaline carbonate; and the precipitate thus generated is calcined.

2. The method of producing a metal complex oxide powder according to claim 1, wherein the metal complex oxide powder is a perovskite-type complex oxide powder.

3. The method for producing a metal complex oxide powder according to claim 1, wherein at least one type selected from the group consisting of lithium carbonate, sodium carbonate, potassium carbonate, and the alkaline carbonate is ammonium carbonate.

4. The method for producing a metal complex oxide powder according to claim 1, wherein, in the general formula ABO₃, a main component of an A site is Ca₍₁₋ₓ₎Mₓ, wherein M is at least one element selected from the group consisting of yttrium and a lanthanoid, and x is in the range of 0.001 to 0.05; and a main component of a B site is Mn.

5. The method for producing a metal complex oxide powder according to claim 2, wherein at least one type selected from the group consisting of lithium carbonate, sodium carbonate, potassium carbonate, and the alkaline carbonate is ammonium carbonate.

6. The method for producing a metal complex oxide powder according to claim 2, wherein, in the general formula ABO₃, a main component of an A site is Ca₍₁₋ₓ₎Mₓ, wherein M is at least one element selected from the group consisting of yttrium and a lanthanoid, and x is in the range of 0.001 to 0.05; and a main component of a B site is Mn.

7. The method for producing a metal complex oxide powder according to claim 3, wherein, in the general formula ABO₃, a main component of an A site is Ca₍₁₋ₓ₎Mₓ, wherein M is at least one element selected from the group consisting of yttrium and a lanthanoid, and x is in the range of 0.001 to 0.05; and a main component of a B site is Mn.
